(19) United States
(12) Patent Application Publication
(10) Pub. No.: US 2014/0216998 A1
(43) Pub. Date: Aug. 7, 2014

(54) DEWATERING SYSTEM FOR OIL STORAGE TANKS

(71) Applicant: KING FAHD UNIVERSITY OF PETROLEUM AND MINERALS, DHAHRAN (SA)

(72) Inventors: LUAI M. AL-HADHRAMI, DHAHRAN (SA); AFTAB AHMAD, DHAHRAN (SA)

(73) Assignee: KING FAHD UNIVERSITY OF PETROLEUM AND MINERALS, DHAHRAN (SA)

(21) Appl. No.: 13/760,002

(22) Filed: Feb. 5, 2013

(51) Int. Cl. B01D 17/02

(52) U.S. Cl. CPC B01D 17/02
USPC 210/138; 210/194

(57) ABSTRACT

The dewatering system for oil storage tanks includes a dewatering pipe or line extending from the bottom of the oil tank, and a recirculation or return line teed into the dewatering pipe and extending back to the tank. The return line may include multiple branches to the tank, which permit return flow across the bottom of the tank to flush scale, sediment, and/or other residue from the bottom of the tank. A sensitive oil/water sensor is installed at the tee. When a minute fraction of oil is detected in the water, a valve downstream of the tee and sensor is automatically closed to return the oil and water mix back to the tank before any oil can leave the system. The system may include a timer mechanism to operate the recirculation system automatically on a periodic basis.

### BACKGROUND OF THE INVENTION

1. Field of the Invention

The present invention relates generally to the separation of different liquids from one another, and particularly to a dewatering system for oil storage tanks wherein an automated system provides for the removal of collected or trapped water from an oil storage tank.

2. Description of the Related Art

The collection of at least some small fraction of water in petroleum (oil) storage tanks is a chronic problem in the petroleum industry. Water can accumulate in such storage tanks due to entrainment with oil as it is pumped from the ground or from some other source, and water can condense within the airspace in a partially filled tank. As water is more dense than the oil or other petroleum product within the tank, the water will settle to the bottom of the tank.

Accordingly, various systems have been developed in the past for the removal of water residue from oil storage tanks. Most earlier systems relied upon a human operator opening a drain valve at the bottom of the tank, and monitoring the appearance of the water as it flowed from the tank and drain valve. When oil was observed in the water, the operator would close the drain valve. Obviously this technique can be somewhat wasteful, as it generally requires a fair amount of oil mixed with the water in order for the operator to observe the water and react by shutting off the valve. Aside from the direct economic loss of the oil that escapes with the water, the oil entrained with the drained water must be removed from that water before the water can be used for other purposes or drained back into a clean natural water source.

Thus, a dewatering system for oil storage tanks solving the aforementioned problems is desired.

### SUMMARY OF THE INVENTION

The dewatering system for oil storage tanks includes a dewatering pipe or line having a recirculation or return line extending therefrom and back to the oil tank. The return line preferably includes a plurality of branches extending to the lower portion of the tank in order to provide flow across the bottom of the tank to wash scale, sludge, and/or other debris from the bottom of the tank. An oil/water sensor is installed in the tee of the dewatering pipe and the return line. The sensor is an electronic ppm sensor providing a high degree of resolution, being capable of detecting amounts of oil in the water down to fifty parts per million. The system is completely automated. When the sensor detects an oil fraction of more than fifty parts per million in the water outflow, the system automatically shuts off the outgoing water flow and returns the entire flow back to the oil tank by means of a pump in the recirculation or return line. The shutoff valve is downstream of the sensor and tee. Any oil in the water is captured upstream of the shutoff valve before leaving the system. An electronic timer maintains the pump in operation and holds a solenoid valve open in the return line for a predetermined amount of time to ensure that the water containing an oil fraction is completely returned to the tank. The system may also be operated by an automatic timer to close the dewatering pipe and actuate the pump for recirculation on a periodic basis.

These and other features of the present invention will become readily apparent upon further review of the following specification and drawings.

### BRIEF DESCRIPTION OF THE DRAWINGS

FIG. 1 is a schematic plan view of a dewatering system for an oil storage tank according to the present invention, illustrating its various components.

FIG. 2 is a schematic side elevation view of the oil storage tank of the dewatering system for an oil storage tank according to the present invention, illustrating various components associated therewith.

Similar reference characters denote corresponding features consistently throughout the attached drawings.

### DETAILED DESCRIPTION OF THE PREFERRED EMBODIMENTS

The dewatering system for oil storage tanks provides an automated system for removing water that has collected in an oil storage tank, and returning any water having oil therein back to the oil storage tank. The system is also configured to provide a periodic flow of water back into the bottom of the tank to flush scale, sediment, and/or other impurities from the bottom of the tank.

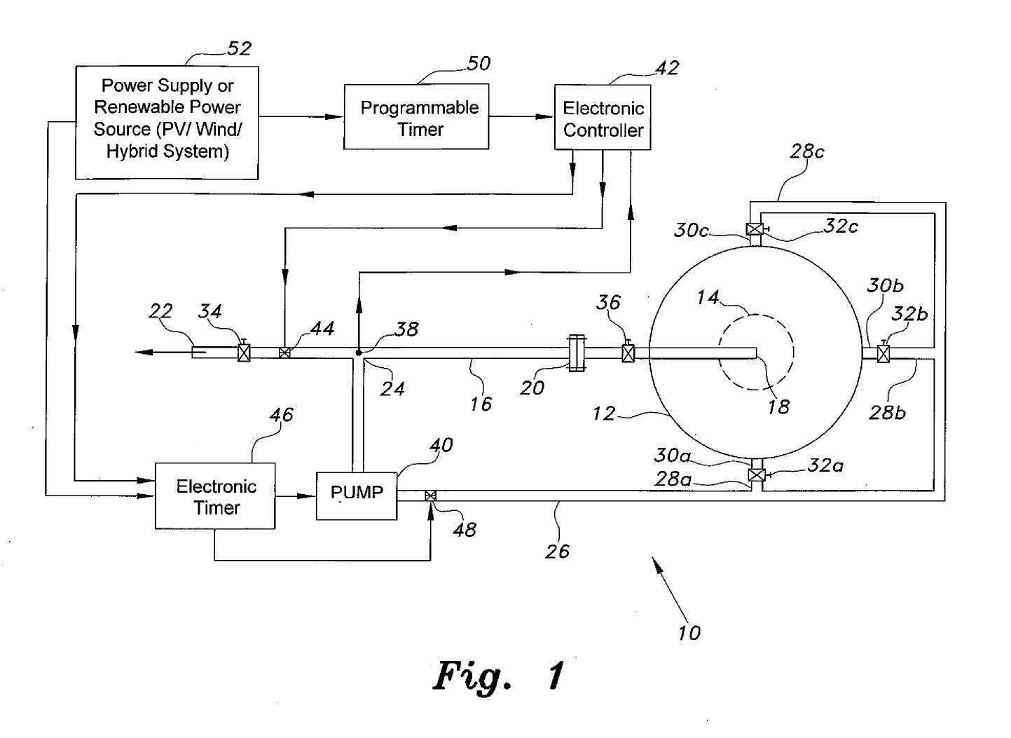

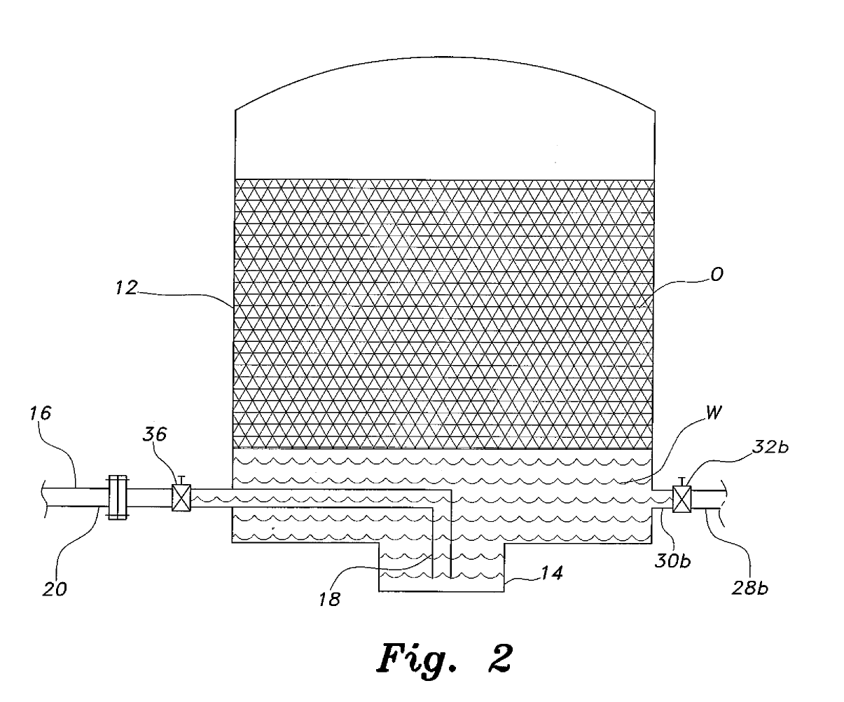

FIG. 1 of the drawings provides a schematic view of the dewatering system 10. The system extends from an oil storage tank 12 having a sump 14 therein. As water has a higher specific gravity than most oils, any water will tend to collect in the bottom portion of the tank 12, beneath the oil, as shown in FIG. 2 by the water W beneath the oil O in the tank. Accordingly, the dewatering pipe or line 16 has an inlet 18 extending from its oil tank connection end 20 (e.g., at the butt flange shown in FIGS. 1 and 2). The inlet 18 extends down into the sump 14 of the oil tank 12 to draw water therefrom. The dewatering line 16 further has an outlet end 22 opposite its oil tank connection end 20. It should be noted that the dewatering line 16 is not intended to deliver oil from the tank 12, but is strictly configured for the purpose of removing water from the tank 12. Any oil that is drawn into the dewatering line 16 will be in no more than trace amounts, as described further below.

The dewatering line 16 includes a tee 24 installed therein between the oil tank connection end 20 and the outlet end 22. The stem of the tee 24 comprises one end portion of a water return line 26 extending therefrom, the opposite end of the return line 26 having an oil tank connection end. While the return line 26 may comprise a single continuous pipe having a single connection to the oil tank 12, the preferred embodiment illustrated in FIG. 1 includes a plurality of water return line branches 28a through 28c, respectively. Each of the branches has an oil tank connection end 30a through 30c. Each of the branches 28a through 28c preferably includes a manually operated shutoff valve 32a through 32c, adjacent to its oil tank connection end. An additional manually operated first shutoff valve 34 is installed in the dewatering line between the outlet end 22 of the line and the tee 24. Another manually operated second shutoff valve 36 is installed in the dewatering line adjacent its oil tank connection end 20, e.g., external to the tank 12 between the butt flange and the inlet end 18 of the line 16 inside the tank.

An oil/water sensor 38 is installed in the tee 24 of the dewatering line 16. The oil/water sensor 38 is a sensitive electronic device, capable of detecting only a few parts per million of oil mixed with the water flowing through the dewatering pipe 16. Such sensors are conventional, and are known as “ppm” (parts per million) sensors. A recirculation pump 40 is installed in the return line 26, to pump any water having even trace amounts of oil therein back to the oil storage tank 12.

The dewatering system is controlled by a conventional microprocessor-based programmable logic controller or other electronic controller 42 that communicates electronically with the oil/water sensor 38 and other components. The electronic controller 42 receives signals from the oil/water sensor 38 to control the operation of the recirculation pump 40, a first solenoid valve 44 disposed in the dewatering line 16 between the outlet end 22 and the tee 24, and an electronic timer 46 that, in turn, communicates with the recirculation pump 40 and with a second solenoid valve 48 disposed in the return line 26 between the pump 40 and the oil tank connection end(s) 30a, 30b, and 30c of the return line. The electronic controller 42 is driven or operated, in turn, by a programmable timer 50. The programmable timer 50, the electronic controller 42, the electronic timer 46, the recirculation pump 40, and the two solenoid valves 44 and 48 ultimately receive their operating power from a power supply 52 (e.g., power grid, generator, wind power, solar power, etc.).

The normal operation of the system is controlled according to signals received by the electronic controller 42 from the oil/water sensor 38. When no oil (or at least no oil above a predetermined small fraction) is detected by the sensor 38, the electronic controller 42 opens the first solenoid valve 44 in the dewatering line 16 and closes the second solenoid valve 48 in the return line 26. The first manual valve 34 between the outlet 22 and the tee 24 of the dewatering pipe 16, the second manual valve 36 at the oil tank connection end 20 of the dewatering pipe 16, and at least one of the three manually operated shutoff valves 32a, 32b, and/or 32c in the return line branches 28a through 28c that connect to the oil tank 12, are normally open to permit normal operation. They may be closed to permit maintenance or repair of the system.

Preferably, the oil/water sensor 38 is set to provide a signal when a very small amount of oil is detected in the water, e.g., fifty parts per million (50 ppm), or 0.005 percent, although the system may be set to operate at other detected fractions of oil. When such an oil fraction (or greater) is detected by the oil water sensor 38, the electronic controller 42 sends a signal to the first solenoid valve 44 to close the valve, thus shutting off water outflow (and any oil fraction therein) from the dewatering pipe 16. Simultaneously with the above valve closure, the electronic controller 42 sends a signal to the electronic timer 46 to cause the timer 46 to actuate the recirculation pump 40 and to open the previously closed second solenoid valve 48. This results in all water (and oil mixed therein) in the dewatering line 16 between the tee 24 and the tank 12, and all water (and any oil therein) in the return line 26 being recirculated back into the oil tank 12. The electronic timer 46 may be set to hold the second solenoid valve 48 open and to operate the recirculation pump 40 for a predetermined period of time, after which the valve 48 is closed and the pump 40 is shut down. The recirculation procedure begins anew if the sensor 38 detects more oil in the dewatering pipeline 16, after the first solenoid valve 44 is reopened to allow flow through the line 16.

The programmable timer 50 may be set to actuate the system independently of the detection of oil in the water by the sensor 38. If the programmable timer 50 is set to do so, it sends a signal periodically to the electronic controller 42 to close the first solenoid valve 44 and a corresponding signal to the electronic timer 46 to open the second solenoid valve 48 and actuate the pump 40. The water recirculation operation is identical with that described further above, excepting that it was not initiated by receipt of a signal from the oil/water sensor 38.

The multiple return line branches 28a through 28c extending into the bottom of the oil tank 12 provide additional benefit, in that the water flowing back into the bottom of the tank 12 during recirculation will tend to create turbulence in the bottom of the tank to flush any scale, sediment, and/or debris from the tank bottom. This benefit will occur at each time the recirculation system is actuated, whether by a signal from the oil/water sensor 38 to the electronic controller 42 or by a periodic signal to the controller 42 from the programmable timer 50. The various manual valves 32a through 32c may be opened or closed as desired to direct the return flow into the bottom of the tank 12, e.g., two of the three valves may be closed with only one remaining open to direct a stronger flow through that single open valve, or a crossflow may be set up by opening two of the three valves, etc.

The above-described dewatering system results in a completely automated system that virtually assures that no appreciable amount of oil will escape with water removed from the oil storage tank. The system is economical and quite reliable, in that it does not rely upon human intervention for its operation other than for the occasional opening or closure of manually operated valves for periodic maintenance or the like. The dewatering system provides the additional benefit of scale and sludge removal from the bottom of the oil storage tank, which results in additional economies of operation for the oil storage system.

It is to be understood that the present invention is not limited to the embodiments described above, but encompasses any and all embodiments within the scope of the following claims.

We claim:

1. A dewatering system for an oil storage tank, comprising:
a dewatering line having an oil tank connection end and an outlet end opposite the oil tank connection end;
a tee disposed in the dewatering line between the oil tank connection end and the outlet end;
an oil/water sensor disposed in the tee;
a return line extending from the tee, the return line having at least one oil tank connection end; and
a recirculation pump disposed in the return line.

2. The dewatering system for an oil storage tank according to claim 1, further comprising:
a first solenoid valve disposed in the dewatering line between the outlet end thereof and the tee;
an electronic controller communicating with the sensor and the first solenoid valve; and
a programmable timer communicating with the electronic controller.

3. The dewatering system for an oil storage tank according to claim 2, further comprising:
a second solenoid valve disposed in the return line between the oil tank connection end thereof and the pump; and
an electronic timer communicating with the electronic controller, the pump, and the second solenoid valve.

4. The dewatering system for an oil storage tank according to claim 1, wherein the return line has a plurality of return line branches, each of the return line branches having an oil tank connection end.

5. The dewatering system for an oil storage tank according to claim 4, further comprising a manual shutoff valve disposed in each of the return line branches.

6. The dewatering system for an oil storage tank according to claim 1, further comprising:
a first manual shutoff valve disposed in the dewatering line between the outlet end thereof and the tee; and
a second manual shutoff valve disposed in the return line between the oil tank connection end thereof and the pump.

7. The dewatering system for an oil storage tank according to claim 1, wherein the oil/water sensor is an electronic ppm sensor.

8. A dewatering system for an oil storage tank, comprising:
a dewatering line having an oil tank connection end and an outlet end opposite the oil tank connection end;
a tee disposed in the dewatering line between the oil tank connection end and the outlet end;
an electronic ppm oil/water sensor disposed in the dewatering line;
a return line extending from the tee, the return line having at least one oil tank connection end;
a recirculation pump disposed in the return line;
a first solenoid valve disposed in the dewatering line between the outlet end thereof and the tee;
an electronic controller communicating with the sensor and the first solenoid valve; and
a programmable timer communicating with the electronic controller.

9. The dewatering system for an oil storage tank according to claim 8, wherein the sensor is disposed in the tee.

10. The dewatering system for an oil storage tank according to claim 8, wherein the return line has a plurality of return line branches, each of the return line branches having an oil tank connection end.

11. The dewatering system for an oil storage tank according to claim 10, further comprising a manual shutoff valve disposed in each of the return line branches.

12. The dewatering system for an oil storage tank according to claim 8, further comprising:
a second solenoid valve disposed in the return line between the oil tank connection end thereof and the pump; and
an electronic timer communicating with the electronic controller, the pump, and the second solenoid valve.

13. The dewatering system for an oil storage tank according to claim 8, further comprising:
a first manual shutoff valve disposed in the dewatering line between the outlet end thereof and the tee; and
a second manual shutoff valve disposed in the return line between the oil tank connection end thereof and the pump.

14. A dewatering system for an oil storage tank, comprising:
a dewatering line having an oil tank connection end and an outlet end opposite the oil tank connection end;
a tee disposed in the dewatering line between the oil tank connection end and the outlet end;
an oil/water sensor disposed in the dewatering line;
a return line extending from the tee, the return line having a plurality of return line branches, each of the return line branches having an oil tank connection end; and
a recirculation pump disposed in the return line.

15. The dewatering system for an oil storage tank according to claim 14, wherein the sensor is disposed in the tee.

16. The dewatering system for an oil storage tank according to claim 14, further comprising:
a first solenoid valve disposed in the dewatering line between the outlet end thereof and the tee;
an electronic controller communicating with the sensor and the first solenoid valve; and
a programmable timer communicating with the electronic controller.

17. The dewatering system for an oil storage tank according to claim 16, further comprising:
a second solenoid valve disposed in the return line, between the oil tank connection end thereof and the pump; and
an electronic timer communicating with the electronic controller, the pump, and the second solenoid valve.

18. The dewatering system for an oil storage tank according to claim 14, further comprising a manual shutoff valve disposed in each of the return line branches.

19. The dewatering system for an oil storage tank according to claim 14, further comprising:
a first manual shutoff valve disposed in the dewatering line between the outlet end thereof and the tee; and
a second manual shutoff valve disposed in the return line between the oil tank connection end thereof and the pump.

20. The dewatering system for an oil storage tank according to claim 14, wherein the oil/water sensor is an electronic ppm sensor.
